(19) United States
(12) Patent Application Publication
(10) Pub. No.: US 2021/0280873 A1
(43) Pub. Date: Sep. 9, 2021

(54) CATHODE, ALL-SOLID SECONDARY BATTERY INCLUDING CATHODE, AND METHOD OF PREPARING ALL-SOLID SECONDARY BATTERY

(71) Applicant: Samsung SDI Co., Ltd., Yongin-si (KR)

(72) Inventors: Junhwan KU, Seongnam-si (KR); Toshinori SUGIMOTO, Hwaseong-si (KR)

(21) Appl. No.: 16/997,381

(22) Filed: Aug. 19, 2020

(30) Foreign Application Priority Data
Mar. 3, 2020 (KR) 10-2020-0026795

(51) Int. Cl. H01M 4/62; H01M 10/0562; H01M 10/0585; H01M 4/36; H01M 4/38; H01M 4/40; H01M 10/0525

(52) U.S. Cl. CPC H01M 4/625; H01M 10/0562; H01M 10/0585; H01M 4/366; H01M 2004/021; H01M 4/405; H01M 10/0525; H01M 2300/0068; H01M 4/382

(57) ABSTRACT

A cathode includes a cathode active material layer, wherein the cathode active material layer includes a cathode active material and a sulfide solid electrolyte, and wherein the cathode active material layer is free of a conductive additive or includes a fibrous conductive additive in a range of greater than 0 weight percent to about 0.4 weight percent, based on the total weight of the cathode active material layer.

### CROSS-REFERENCE TO RELATED APPLICATION

This application claims priority to and the benefit of Korean Patent Application No. 10-2020-0026795, filed on Mar. 3, 2020, in the Korean Intellectual Property Office, and all the benefits accruing therefrom under 35 U.S.C. § 119, the content of which is incorporated herein in its entirety by reference.

### BACKGROUND

### 1. Field

The present disclosure relates to a cathode, an all-solid secondary battery including the cathode, and a method of preparing an all-solid secondary battery.

### 2. Description of Related Art

Recently, in accordance with industrial demand, the development of batteries having high energy density and improved safety has become increasingly important. For example, lithium-ion batteries have been put to practical use in the automotive field as well as in information-related equipment and communication equipment. In the field of automobiles, safety precautions are particularly important because they protect human life.

Commercially available lithium-ion batteries use an electrolytic solution including a flammable organic solvent, and thus there is a possibility of overheating and fire when a short circuit occurs. In this regard, an all-solid secondary battery using a solid electrolyte instead of an electrolytic solution has been proposed.

In the all-solid secondary battery, a flammable organic solvent is not used, and thus the possibility of a fire or an explosion, even when a short circuit occurs, may be greatly reduced. Therefore, such an all-solid secondary battery may have increased safety as compared to a lithium-ion battery using a liquid electrolyte.

In an all-solid secondary battery, the solid electrolyte is arranged in a cathode such that there is contact between a cathode active material and the solid electrolyte Also, a conductive additive may be arranged in the cathode to decrease an internal resistance of the all-solid secondary battery.

An increased amount of the conductive additive is used in a cathode of an all-solid secondary battery that requires a high output. When the amount of the conductive additive in the cathode increases, an internal resistance of the cathode may decrease, but an amount of the cathode active material in the cathode may decrease. As a result, an energy density of the all-solid secondary battery may be deteriorated. In this regard, an all-solid secondary battery including a cathode having an improved conductivity and a small amount of a conductive additive, while providing an improved energy density and improved cycle characteristics, is needed.

### SUMMARY

Provided is a cathode having an improved conductivity while having a small amount of a conductive additive.

Provided is an all-solid battery having an improved energy density and improved cycle characteristics by including the cathode.

Additional aspects will be set forth in part in the description which follows and, in part, will be apparent from the description.

According to an aspect, a cathode includes:

a cathode active material layer,

wherein the cathode active material layer includes a cathode active material and a sulfide solid electrolyte, and

wherein the cathode active material layer is free of a conductive additive or includes a fibrous conductive additive in a range of greater than 0 wt % to about 0.4 wt %, based on the total weight of the cathode active material layer.

According to an aspect, an all-solid secondary battery includes:

a cathode, wherein the cathode includes a cathode active material layer,

wherein the cathode active material layer includes a cathode active material and a sulfide solid electrolyte, and

wherein the cathode active material layer is free of a conductive additive or includes a fibrous conductive additive in a range of greater than 0 wt % to about 0.4 wt %, based on the total weight of the cathode active material layer;

an anode including an anode current collector and a first anode active material layer; and

a solid electrolyte layer disposed between the cathode and the anode.

According to an aspect, a method of preparing an all-solid secondary battery includes:

providing an anode layer;

providing a cathode layer including a cathode active material layer;

providing a solid electrolyte layer between the anode layer and the cathode layer to prepare a stack; and

pressing the stack to prepare the all-solid secondary battery,

wherein the cathode active material layer is free of a conductive additive or includes a fibrous conductive additive in a range of greater than 0 wt % to about 0.4 wt % based on the total weight of the cathode active material layer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view of an all-solid secondary battery according to an embodiment;

FIG. 2 is a cross-sectional view of an all-solid secondary battery according to an embodiment; and

FIG. 3 is a cross-sectional view of an all-solid secondary battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Or” means “and/or.” Expressions such as “at least one of,” when preceding a list of elements, modify the entire list of elements and do not modify the individual elements of the list.

Hereinafter, as the present inventive concept allows for various changes and numerous embodiments, particular embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope are encompassed in the present inventive concept.

The terms used herein are merely used to describe particular embodiments, and are not intended to limit the present inventive concept. An expression used in the singular encompasses the expression of the plural, unless it has a clearly different meaning in the context. As used herein, it is to be understood that the terms such as “including,” “having,” and “comprising” are intended to indicate the existence of the features, numbers, steps, actions, components, parts, ingredients, materials, or combinations thereof disclosed in the specification, and are not intended to preclude the possibility that one or more other features, numbers, steps, actions, components, parts, ingredients, materials, or combinations thereof may exist or may be added. The symbol “/” used herein may be interpreted as “and” or “or” according to the context.

In the drawings, the thicknesses of layers and regions are exaggerated or reduced for clarity. Like reference numerals in the drawings denote like elements. Throughout the specification, it will be understood that when a component, such as a layer, a film, a region, or a plate, is referred to as being “on” another component, the component may be directly on the other component or intervening components may be present thereon. Throughout the specification, while such terms as “first,” “second,” etc., may be used to describe various components, such components must not be limited to the above terms. The above terms are used only to distinguish one component from another. In the present specification and drawings, constituent elements having substantially the same functional configuration will be denoted by the same reference numerals, and redundant description will be omitted.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized sense unless expressly so defined herein. Also, the terms will not be interpreted in an overly formal sense unless expressly so defined herein.

Example embodiments of inventive concepts are described herein with reference to cross-sectional illustrations that are schematic illustrations of idealized embodiments of example embodiments. As such, variations from the shapes of the illustrations as a result, for example, of manufacturing techniques and/or tolerances, are to be expected. Thus, example embodiments of inventive concepts should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

A C rate is a discharge rate of a cell, and is obtained by dividing a total capacity of the cell by a total discharge period of time of 1 hour, e.g., a C rate for a battery having a discharge capacity of 1.6 ampere-hours would be 1.6 amperes.

Hereinafter, according to one or more embodiments, a cathode, an all-solid secondary battery, and a method of preparing the all-solid secondary battery will be described in detail.

According to an embodiment, a cathode includes a cathode active material layer, wherein the cathode active material layer includes a cathode active material, and a sulfide-based solid electrolyte, wherein the cathode active material layer is free of a conductive additive or includes a fibrous conductive additive. When the cathode active material layer includes a fibrous conductive additive, an amount of the fibrous conductive additive may be in a range of greater than 0 weight % (wt %) to about 0.4 wt %, based on the total weight of the cathode active material layer. When the cathode is free of a conductive additive (i.e. 0 wt. %) or includes a fibrous conductive additive in a range of greater than 0 weight % (wt %) to about 0.4 wt %, the cathode may be provided with improved conductivity while having a small amount of the conductive additive. Thus, an all-solid secondary battery including the cathode may have an increased energy density and improved cycle characteristics.

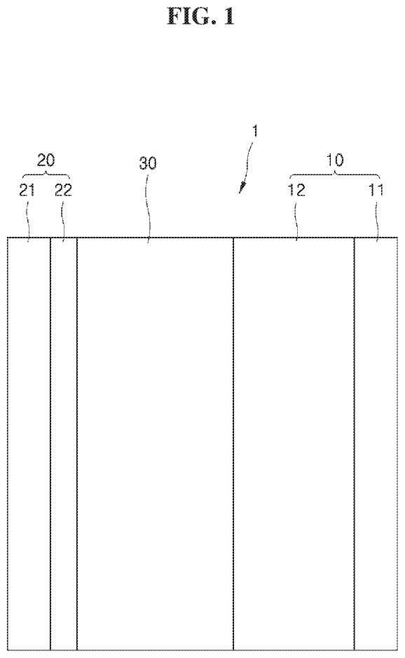

Referring to FIGS. 1 to 3, an all-solid secondary battery 1 includes an anode layer 20 including a first anode active material layer 22, a cathode layer 10 including a cathode active material layer 12, and a solid electrolyte layer 30 disposed between the anode layer 20 and the cathode layer 10.

As used herein, the cathode layer 10 may also be expressed as a cathode 10, and the anode layer 20 may also be expressed as an anode 20, but this is only for convenience of description, and the elements with the same reference numerals denote the same elements.

Cathode Layer

The cathode 10 includes a cathode current collector 11 and the cathode active material layer 12, wherein the cathode active material layer 12 includes a cathode active material, and a sulfide-based solid electrolyte, wherein the cathode active material layer 12 is free of a conductive additive or includes a fibrous conductive additive, wherein an amount of the fibrous conductive additive is in a range of greater than 0 wt % to about 0.4 wt %, based on the total weight of the cathode active material layer 12.

When the cathode active material layer 12 is free of a conductive additive, the cathode active material layer 12 further includes the cathode active material instead of a conductive additive, and thus an amount of the cathode active material in the cathode active material layer 12 may increase. As a result, an energy density of the all-solid secondary battery 1 including the cathode active material layer 12 may increase. Also, when the cathode active material layer 12 includes a fibrous conductive additive in a range of greater than 0 wt % to about 0.4 wt %, the cathode active material layer 12 only includes a small amount of a conductive additive, and thus an amount of the cathode active material in the cathode active material layer 12 may increase. As a result, an energy density of the all-solid secondary battery 1 including the cathode active material layer 12 may increase. An amount of the fibrous conductive additive in the cathode active material layer 12 may be, for example, in a range of greater than 0 wt % to about 0.35 wt %, greater than 0 wt % to about 0.3 wt %, or about 0.1 wt % to about 0.25 wt %.

An aspect ratio of the fibrous conductive additive in the cathode active material layer 12 may be, for example, about 10 or more, about 15 or more, about 20 or more, about 25 or more, or about 30 or more. An aspect ratio of the fibrous conductive additive in the cathode active material layer 12 may be, for example, in a range of about 10 to about 100, about 15 to about 85, about 20 to about 80, about 25 to about 72, or about 30 to about 70. When the fibrous conductive additive includes an aspect ratio in these ranges, the fibrous conductive additive may provide an extended conduction pathway in the cathode active material layer 12 and may facilitate electrical connection between the cathode active material layer 12 and the cathode current collector 11.

A diameter of the fibrous conductive additive may be, for example, about 1 μm or less. A diameter of the fibrous conductive additive may be, for example, in a range of about 0.1 μm to about 1 μm, about 0.2 μm to about 0.95 μm, about 0.3 μm to about 0.9 μm, about 0.4 μm to about 0.85 μm, about 0.5 μm to about 0.8 μm, or about 0.6 μm to about 0.7 μm. A length of the fibrous conductive additive may be, for example, about 10 μm or more. A length of the fibrous conductive additive may be, for example, in a range of about 10 μm to about 100 μm, about 15 μm to about 99 μm, about 20 μm to about 98 μm, about 25 μm to about 97 μm, or about 30 μm to about 95 μm A diameter and a length of the fibrous conductive additive may be selected within these ranges that satisfy the aspect ratio. A length of the fibrous conductive additive in the cathode active material layer 12 may be, for example, greater than a diameter of secondary particles of the cathode active material in the cathode active material layer 12. When the fibrous conductive additive has a length that is greater than a diameter of the secondary particles of the cathode active material, the fibrous conductive additive may provide a conductive pathway between at least two secondary particles of the cathode active material. The length of the fibrous conductive additive may be about 1.1 times or more, about 1.5 times or more, about 2 times or more, about 3 times or more, about 4 times or more, or about 5 times or more of an average diameter of the secondary particles of the cathode active material. The length of the fibrous conductive additive may be about 1.1 times to about 100 times, for example, about 2 to about 90 times, about 5 to about 80 times, about 10 to about 70 times, or about 20 to about 60 times, of an average diameter of the secondary particles of the cathode active material. The diameter and the length of the fibrous conductive additive may be measured from, for example, an electron scanning microscope (SEM) image.

The fibrous conductive additive may be, for example, a carbonaceous material. The carbonaceous material is, for example, a 1-dimensional carbon nanostructure. Examples of the 1-dimensional carbonaceous material may include at least one of a carbon nanofiber (CNF), a carbon nanotube (CNT), a carbon nanobelt, or a carbon nanorod. When the fibrous conductive additive is a carbonaceous material, densities of the cathode active material layer 12 and the all-solid secondary battery 1 that include the carbonaceous fibrous conductive additive may be decreased. As a result, an energy density of the all-solid secondary battery 1 including the carbonaceous fibrous conductive additive may improve. In an embodiment, the fibrous conductive additive may be, for example, a metallic material. Examples of the metallic material may include metal nanofibers, metal nanotubes, and metal nanobelts. Examples of a metal that forms the metallic fibrous conductive additive may include at least one of indium (In), copper (Cu), magnesium (Mg), stainless steel, titanium (Ti), iron (Fe), cobalt (Co), nickel (Ni), zinc (Zn), aluminum (Al), or germanium (Ge). In an embodiment, the fibrous conductive additive may be, for example, a mixture of the carbonaceous material and the metallic material.

The cathode active material layer 12 may not include a particle-phase conductive additive. As used herein, the term “particle-phase conductive additive” denotes particles having an aspect ratio of lower than 3. A shape of the particle-phase conductive additive is not particularly limited, but may include particles of any shape, such as a spherical shape, a non-spherical shape, or a plate-like shape, having an aspect ratio of lower than 3. Examples of the particle-phase conductive additive may include at least one of graphite, carbon black, acetylene black, Ketjen black, furnace black, or a metal powder. The conductive additive may have an electronic conductivity greater than the cathode active material. In an aspect the conductive additive has an electronic conductivity equal to or greater than carbon black, and in an aspect the conductive additive has an electronic conductivity equal to or greater than graphite, and in an aspect the conductive additive has an electronic conductivity equal to or less than silver. The conductive additive may have an electronic conductivity of about 1×10¹ S/cm to about 1×10⁶ S/cm, about 2×10¹ S/cm to about 1×10⁵ S/cm, or about 1×10² S/cm to about 1×10⁴ S/cm.

The cathode current collector 11 may be, for example, a plate or a foil formed of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. The cathode current collector 11 may be omitted. A carbon layer may be coated on a surface of the cathode active material layer 12 of contacting the cathode current collector 11 to reduce an interfacial resistance between the cathode current collector 11 and the cathode active material layer 12.

The cathode active material in the cathode active material layer 12 is a material capable of reversely absorbing and desorbing lithium ions. Examples of the cathode active material may include at least one of a lithium transition metal oxide such as a lithium cobalt oxide (LCO), a lithium nickel oxide, a lithium nickel cobalt oxide, a lithium nickel cobalt aluminum oxide (NCA), a lithium nickel cobalt manganate (NCM), a lithium manganate, a lithium iron phosphate, a nickel sulfide, a copper sulfide, a lithium sulfide, an iron oxide, or a vanadium oxide, but embodiments are not limited thereto, and any suitable cathode active material may be used. The cathode active material may be formed of one of these examples alone or as a mixture of at least two selected from the examples of the cathode active material.

The lithium transition metal oxide may be a compound represented by at least one of LiₐA_{1-b}B′_{b}D₂ (where 0.90≤a≤1 and 0≤b≤0.5); LiₐE_{1-b}B′_{b}O_{2-c}D_{c} (where 0.90≤a≤1, 0≤b≤0.5, and 0≤c≤0.05); LiE_{2-b}B′_{b}O_{4-c}D_{c} (where 0≤b≤0.5 and 0≤c≤0.05); LiₐNi_{1-b-c}Co_{b}B′_{c}D_{α} (where 0.90≤a≤1, 0≤b≤0.5, 0≤c≤0.05, and 0<α≤2); LiₐNi_{1-b-c}Co_{b}B′_{c}O_{2-α}F′_{α} (where 0.90≤a≤1, 0≤b≤0.5, 0≤c≤0.05, and 0<α≤2); LiₐNi_{1-b-c}Co_{b}B′_{c}O_{2-α}F′₂ (where 0.90≤a≤1, 0≤b≤0.5, 0≤c≤0.05, and 0<α<2); LiₐNi_{1-b-c}Mn_{b}B′_{c}D_{α} (where 0.90≤a≤1, 0≤b≤0.5, 0≤c≤0.05, and 0<α<2); LiₐNi_{1-b-c}Mn_{b}B′_{c}O_{2-α}F′_{α} (where 0.90≤a≤1, 0≤b≤0.5, 0≤c≤0.05, and 0<α<2); LiₐNi_{1-b-c}Mn_{b}B′_{c}O_{2-α}F′₂ (where 0.90≤a≤1, 0≤b≤0.5, 0≤c≤0.05, and 0<α<2); LiₐNi_{b}E_{c}G_{d}O₂ (where 0.90≤a≤1, 0≤b≤0.9, 0≤c≤0.5, and 0.001≤d≤0.1), LiₐNi_{b}Co_{c}Mn_{d}GeO₂ (where 0.90≤a≤1, 0≤b≤0.9, 0≤c≤0.5, 0≤d≤0.5, and 0.001≤e≤0.1); LiₐNiG_{b}O₂ (where 0.90≤a≤1 and 0.001≤b≤0.1); LiₐCoG_{b}O₂ (where 0.90≤a≤1 and 0.001≤b≤0.1); LiₐMnG_{b}O₂ (where 0.90≤a≤1 and 0.001≤b≤0.1); LiaMn₂G_{b}O₄ (where 0.90≤a≤1 and 0.001≤b≤0.1); QO₂; QS₂; LiQS₂; V₂O₅, LiV₂O₅; LiI′O₂; LiNiVO₄; Li_{(3-f)}J₂ (PO₄)₃ (where 0≤f≤2); Li_{(3-f)}Fe₂(PO₄)₃ (where 0≤≤f 2); and LiFePO₄. In the compound, A may be at least one of nickel (Ni), cobalt (Co), or manganese (Mn), B′ may be at least one of aluminum (Al), nickel (Ni), cobalt (Co), manganese (Mn), chromium (Cr), iron (Fe), magnesium (Mg), strontium (Sr), vanadium (V), or a rare earth element; D may be at least one of oxygen (O), fluorine (F), sulfur (S), phosphorus (P), and combinations thereof; E may be at least one of cobalt (Co), or manganese (Mn), F′ may be at least one of fluorine (F), sulfur (S), or phosphorus (P), G may be at least one of aluminum (Al), chromium (Cr), manganese (Mn), iron (Fe), magnesium (Mg), lanthanum (La), cerium (Ce), strontium (Sr), or vanadium (V); Q may be at least one of titanium (Ti), molybdenum (Mo), or manganese (Mn), I′ may be at least one of chromium (Cr), vanadium (V), iron (Fe), scandium (Sc), or yttrium (Y); and J may be at least one of vanadium (V), chromium (Cr), manganese (Mn), cobalt (Co), nickel (Ni), or copper (Cu). The compounds used as cathode active material may have a surface coating layer (hereinafter, also referred to as “coating layer”). Alternatively, a mixture of a compound without a coating layer and a compound having a coating layer, the compounds being selected from the compounds listed above, may be used. In an embodiment, the coating layer may include, for example, a coating element compound of an oxide, a hydroxide, an oxyhydroxide, an oxycarbonate, or a hydroxycarbonate of the coating element. In an embodiment, the compounds for the coating layer may be amorphous or crystalline. In an embodiment, the coating element for the coating layer may be at least one of magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), or zirconium (Zr). In an embodiment, the coating layer may be formed using any method that does not adversely affect the physical properties of the cathode active material. For example, the coating layer may be formed using a spray coating method or a dipping method. Any suitable coating method may be used.

The cathode active material may include, for example, a lithium salt of a transition metal oxide that has a layered rock-salt type structure. For example, the “layered rock-salt type structure” refers to a structure in which an oxygen atom layer and a metal atom layer are alternately and regularly arranged in a <111> direction in a cubic rock-salt type structure, where each of the atom layers forms a two-dimensional flat plane. The “cubic rock-salt type structure” refers to a sodium chloride (NaCl) type structure, which is one of the crystalline structures, in particular, to a structure in which face-centered cubic (fcc) lattices respectively formed of anions and cations that are shifted by only a half of the ridge of each unit lattice. Examples of the lithium transition metal oxide having the layered rock-salt type structure may include a ternary lithium transition metal oxide expressed as LiNiₓCo_{y}Al_{z}O₂ (NCA) or LiNiₓCo_{y}Mn_{z}O₂ (NCM) (where 0<x<1, 0<y<1, 0<z<1, and x+y+z=1). When the cathode active material includes a ternary transition metal oxide having the layered rock-salt type structure, an energy density and thermal stability of an all-solid secondary battery 1 may improve.

The cathode active material may be covered by a coating layer. The coating layer is any suitable material that may be used as a coating layer of a cathode active material of an all-solid secondary battery. The coating layer may be, for example, Li₂O—ZrO₂.

When the cathode active material includes nickel (Ni) as a ternary lithium transition metal oxide such as NCA or NCM, a capacity density of the all-solid secondary battery increases, and thus metal elution from the cathode active material in a charged state may be reduced. As a result, the cycle characteristics of the all-solid secondary battery 1 in a charged state improve. For example, the cathode active material having Ni may be LiNiₐCo_{b}Al_{c}O₂ (NCA) (where 0.5<a<1, 0<b<0.5, 0<z<0.5, and a+b+c=1) or LiNiₓCo_{y}Mn_{z}O₂ (NCM) (where 0<x<1, 0<y<1, 0<z<1, and x+y+z=1). The amount of Ni in the cathode active material may be stoichiometrically greater than the Co and Al in the NCA and/or greater than the Co and Mn in the NCM.

A shape of the cathode active material may be, for example, a particle shape such as a true spherical shape or an elliptical shape. A particle diameter of the cathode active material is not particularly limited and may be in a suitable range useful in an all-solid secondary battery. An amount of the cathode active material in the cathode active material layer 12 is not particularly limited and may be in a suitable range useful in a cathode layer of an all-solid secondary battery.

An amount of the cathode active material in the cathode active material layer 12 may be, for example, about 85 wt % or more, about 86 wt % or more, about 87 wt % or more, about 88 wt % or more, about 89 wt % or more, about 89.5 wt % or more, about 90 wt % or more, about 91 wt % or more, about 92 wt % or more, or about 95 wt % or more, based on the total weight of the cathode active material layer 12. An amount of the cathode active material in the cathode active material layer 12 may be, for example, in a range of about 85 wt % to about 99.5 wt %, about 86 wt % to about 99 wt %, about 87 wt % to about 98.5 wt %, about 88 wt % to about 98 wt %, about 89 wt % to about 97.5 wt %, about 89.5 wt % to about 97 wt %, about 90 wt % to about 96.5 wt %, about 91 wt % to about 96 wt %, about 92 wt % to about 95.5 wt %, or about 93 wt % to about 95 wt %, based on the total weight of the cathode active material layer 12. When the cathode active material layer 12 has a cathode active material within these ranges, an energy density of the all-solid secondary battery 1 may improve.

The sulfide-based solid electrolyte in the cathode active material layer 12 may, for example, include at least one of Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive integer, and Z is one selected from Ge, Zn, and Ga), Li₂S—GeS₂, Li₂S—SiS₂—Li₃PO₄, or Li₂S—SiS₂-LiₚMO_{q} (where p and q are each a positive integer, and M is at least one of P, Si, Ge, B, Al, Ga, or In). For example, the sulfide-based solid electrolyte may include at least one of Li₇P₃S₁₁, Li₇PSe, Li₄P₂S₆, Li₃PS₆, Li₃PS₄, or Li₂P₂S₆. The sulfide-based solid electrolyte may be prepared by melt-cooling starting materials (e.g., Li₂S or P₂S₅), or mechanical milling the starting materials. Subsequently, the resultant may be heat-treated. The sulfide-based solid electrolyte may be amorphous or crystalline and may be a mixture thereof.

Also, the sulfide-based solid electrolyte may include sulfur (S), phosphorus (P), or lithium (Li), as component elements in the sulfide-based solid electrolyte material. For example, the solid electrolyte may be a material including Li₂S—P₂S₅. When Li₂S—P₂S₅ is used as a sulfide-based solid electrolyte material that forms the solid electrolyte, a mixed molar ratio of Li₂S and P₂S₅ (Li₂S:P₂S₅) may be, for example, in a range of about 50:50 to about 90:10.

The sulfide-based solid electrolyte in the cathode active material layer 12 may include an argyrodite-type solid electrolyte represented by Formula 1:

Li₁₂₋ₙ₋ₓAX₆₋ₓY′ₓ Formula 1

wherein, in Formula 1,

A is P, As, Ge, Ga, Sb, Si, Sn, Al, In, Ti, V, Nb, or Ta,

X is S, Se, or Te,

Y′ is Cl, Br, I, F, CN, OCN, SCN, or N₃, and

n is an oxidation number of A, and 0≤x≤2.

For example, the argyrodite-type solid electrolyte may include at least one selected from Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). For example, the argyrodite-type solid electrolyte may include at least one of Li₆PS₅Cl, Li₆PS₅Br, Li_{5.75}PS_{4.75}I_{1.25}, Li_{5.75}PS_{4.75}Cl_{1.25}, or Li_{5.75}PS_{4.75}Br_{1.25}.

A weight ratio of the sulfide-based solid electrolyte and the cathode active material in the cathode active material layer 12 may be, for example, about 1:8 or more, about 1:9 or more, or about 1:10 or more. A weight ratio of the sulfide-based solid electrolyte and the cathode active material in the cathode active material layer 12 may be, for example, in a range of about 1:8 to about 1:30, about 1:8 to about 1:25, about 1:8 to about 1:20, about 1:8 to about 1:15, about 1:8 to about 1:13, or about 1:8 to about 1:12. For example, an amount of the cathode active material may be in a range of about 800 parts by weight to about 3000 parts by weight, based on 100 parts by weight of the sulfide-based solid electrolyte. When the all-solid secondary battery 1 includes the cathode active material of about 800 parts by weight or more, based on 100 parts by weight of the sulfide-based solid electrolyte in the cathode active material layer 12, an energy density of the all-solid secondary battery 1 including the cathode active material layer 12 may improve.

Additives such as a binder, a filler, a dispersant, and an ion conducting agent may be added to the cathode layer 10 in addition to the cathode active material and the solid electrolyte. Examples of the binder are styrene butadiene rubber (SBR), polytetrafluoroethylene, polyvinylidene fluoride, and polyethylene. The coating agent, the dispersant, and the ion conducting agent that may be appropriately added to the cathode layer 10 may be suitable materials that can be used in an electrode of a solid secondary battery.

In the all-solid secondary battery 1 including the cathode layer 10, the contact area (S) between the cathode active material and the sulfide-based solid electrolyte calculated as defined in Equation 1 using a galvanostatic intermittent titration technique (GITT) is about 67% or more, about 70% or more, or about 75% or more (e.g. up to 100%) of a theoretical area of the cathode active material. The detailed method of measuring the contact area (S) may be referred to in Evaluation Example 4.

D^{GITT}=(4/πτ)×(m_{B}V_{M}/M_{b}S)²×(ΔEₛ/ΔEₜ)² Equation 1

wherein, in Equation 1:

D^{GITT} is a diffusion coefficient of lithium ions;

τ is a duration (seconds) for applying constant-current pulses;
m_{B} is a mass (grams) of the cathode active material;

V_{M} is a molar volume (cubic centimeters per mol, cm³/mol) of the cathode active material;

M_{b} is a molar weight (grams per mol, g/mol) of the cathode active material;

S is a contact area (square centimeters, cm²) of the cathode active material and the electrolyte;

ΔEₛ is a steady-state voltage change (volts); and

ΔEₜ is a voltage change (volts) in the duration for applying constant-current pulses excluding an IR drop (i.e. voltage loss (drop) that occurs when current flows through resistance).

Solid Electrolyte Layer

Referring to FIGS. 1 to 3, the solid electrolyte layer 30 includes a solid electrolyte disposed between the cathode layer 10 and the anode layer 20.

The solid electrolyte in the solid electrolyte layer 30 may be, for example, a sulfide-based solid electrolyte. The sulfide-based solid electrolyte may be identical to or different from the sulfide-based solid electrolyte in the cathode layer 10.

Details regarding the sulfide-based solid electrolyte may be the same as the description of the sulfide-based solid electrolyte defined in relation to the cathode layer 10.

An elastic modulus (e.g., Young's modulus) of the solid electrolyte may be, for example, about 35 gigapascal (GPa) or less, about 30 GPa or less, about 27 GPa or less, about 25 GPa or less, or about 23 GPa or less. An elastic modulus (e.g., Young's modulus) of the solid electrolyte may be, for example, in a range of about 10 GPa to about 35 GPa, about 15 GPa to about 35 GPa, about 15 GPa to about 30 GPa, or about 15 GPa to about 25 GPa. When the solid electrolyte has an elastic modulus within these ranges, pressing and/or sintering of the solid electrolyte may be facilitated.

For example, the solid electrolyte layer 30 may further include a binder. Examples of the binder in the solid electrolyte layer 30 may include at least one of styrene butadiene rubber (SBR), polytetrafluoroethylene, polyvinylidene fluoride, or polyethylene, but embodiments are not limited thereto, and any suitable binder may be used. The binder of the solid electrolyte layer 30 may be identical to or different from the binders of the cathode active material layer 12 and the first anode active material layer 22.

Anode Layer

Referring to FIGS. 1 to 3, the anode layer 20 includes the anode current collector layer 21 and the first anode active material layer 22.

A thickness of the first anode active material layer 22 may be, for example, about 50% or less, about 40% or less, about 30% or less, about 20% or less, about 10% or less, or about 5% or less of a thickness of the cathode active material layer 12. A thickness of the first anode active material layer 22 may be, for example, in a range of about 1 micrometer (μm) to about 20 μm, about 2 μm to about 10 μm, or about 3 μm to about 7 μm. When the thickness of the first anode active material layer 22 is too thin, lithium dendrites formed between the first anode active material layer 22 and the anode current collector 21 destroy the first anode active material layer 22, and thus cycle characteristics of the all-solid secondary battery 1 may not improve. When the thickness of the first anode active material layer 22 is too thick, an energy density of the all-solid secondary battery 1 deteriorates and an internal resistance of the all-solid secondary battery 1 by the first anode active material layer 22 increases, and thus cycle characteristics of the all-solid secondary battery 1 may not improve.

For example, when the thickness of the first anode active material layer 22 decreases, a charge capacity of the first anode active material layer 22 may decrease. The charge capacity of the first anode active material layer 22 may be, for example, about 50% or less, about 40% or less, about 30% or less, about 20% or less, about 10% or less, about 5% or less, or about 2% or less of a charge capacity of the cathode active material layer 12. The charge capacity of the first anode active material layer 22 may be, for example, in a range of about 0.1% to about 50%, about 0.2% to about 40%, about 0.3% to about 30%, about 0.4% to about 20%, about 0.5% to about 10%, about 0.6% to about 5%, or about 0.7% to about 2% of a charge capacity of the cathode active material layer 12. When the charge capacity of the first anode active material layer 22 is too low, a thickness of the first anode active material layer 22 is too thin. When the thickness of the first anode active material layer 22 is too thin, lithium dendrites form between the first anode active material layer 22 and the anode current collector 21 during repeated charge/discharge cycles, which deteriorate the first anode active material layer 22, and cycle characteristics of the all-solid secondary battery 1 may not improve. When the thickness of the first anode active material layer 22 is too thick, an energy density of the all-solid secondary battery 1 deteriorates and an internal resistance of the all-solid secondary battery 1 by the first anode active material layer 22 increases, and thus cycle characteristics of the all-solid secondary battery 1 may not improve.

The charge capacity of the cathode active material layer 12 is calculated by multiplying a charge capacity density (milliampere hours per gram, mAh/g) of the cathode active material by a weight of the cathode active material in the cathode active material 12. When various types of materials are used as the cathode active material, a value of a charge capacity density times a weight of each of the cathode active materials is calculated, and the total of these values refers to a charge capacity of the cathode active material layer 12. A charge capacity of the first anode active material layer 22 may be calculated in the same manner. That is, a charge capacity of the first anode active material layer 22 is obtained by multiplying a charge capacity density (mAh/g) of the anode active material by a weight of the anode active material in the first anode active material layer 22. When various types of materials are used as the anode active material, a value of a charge capacity density times a weight of each of the anode active materials is calculated, and the total of these values refers to a charge capacity of the first anode active material layer 22. The charge capacity densities of the cathode active material and the anode active material are capacities estimated by using an all-solid half-cell in which lithium metal is used as a reference electrode. The charge capacities of the cathode active material layer 12 and the first anode active material layer 22 are directly measured by charge capacity measurement using the all-solid half-cell. When the measured charge capacities are divided by a weight of each of the active materials, a charge capacity density may be obtained. In an embodiment, the charge capacities of the cathode active material layer 12 and the first anode active material layer 22 may be initial charge capacities measured in the 1st charge cycle.

The first anode active material layer 22 may include, for example, an anode active material that forms an alloy or a compound with lithium.

The anode active material in the first anode active material layer 22 may be, for example, in the form of a particle. An average particle diameter of the anode active material in the form of a particle may be, for example, about 4 μm or less, about 3 μm or less, about 2 μm or less, about 1 μm or less, or about 900 nanometers (nm) or less. An average particle diameter of the anode active material in the form of particles may be, for example, in a range of about 10 nm to about 4 μm, about 15 nm to about 3 μm, about 20 nm to about 2 μm, about 25 nm to about 1 μm, or about 30 nm to about 900 nm. When an average particle diameter of the anode active material is within these ranges, reversible absorbing and/or desorbing of lithium during charge/discharge may be facilitated. The average particle diameter of the anode active material may be, for example, a volume-converted median diameter (D50) measured by using a laser diffraction particle diameter distribution meter.

The anode active material in the first anode active material layer 22 may include, for example, at least one of a carbonaceous anode active material, a metal anode active material, or metalloid anode active material.

The carbonaceous anode active material may be, for example, amorphous carbon. Examples of the amorphous carbon may include at least one of carbon black (CB), acetylene black (AB), furnace black (FB), Ketjen black (KB), or graphene, but embodiments are not limited thereto, and any suitable amorphous carbon may be used. The amorphous carbon refers to carbon that has no crystallinity or a very low crystallinity, which may be different from crystalline carbon or graphite carbon.

For example, the metal or metalloid anode active material may include at least one of gold (Au), platinum (Pt), palladium (Pd), silicon (Si), silver (Ag), aluminum (Al), bismuth (Bi), tin (Sn), or zinc (Zn), but embodiments are not limited thereto, and any suitable metal anode active material or a metalloid anode active material capable of forming an alloy or a compound with lithium may be used. For example, nickel (Ni) does not form an alloy with lithium and thus is not a metal anode active material.

The first anode active material layer 22 may include one of these anode active materials or may include a mixture of a plurality of different anode active materials. For example, the first anode active material layer 22 may include only amorphous carbon or may also include at least one of gold (Au), platinum (Pt), palladium (Pd), silicon (Si), silver (Ag), aluminum (Al), bismuth (Bi), tin (Sn), or zinc (Zn). In an embodiment, the first anode active material layer 22 may include a mixture including amorphous carbon and at least one of gold (Au), platinum (Pt), palladium (Pd), silicon (Si), silver (Ag), aluminum (Al), bismuth (Bi), tin (Sn), or zinc (Zn). A mixing ratio of the mixture of amorphous carbon to the element such as silver (Ag) may be a weight ratio in a range of about 10:1 to about 1:2, about 5:1 to about 1:1, or about 4:1 to about 2:1, but embodiments are not limited thereto, and the mixing ratio may be selected according to characteristics of the all-solid secondary battery 1. When the anode active material has the foregoing composition, cycle characteristics of the all-solid secondary battery 1 may improve.

The anode active material in the first anode active material layer 22 may include, for example, a mixture including first particles formed of amorphous carbon and a second particle formed of a metal or a metalloid. Examples of the metal or metalloid may include gold (Au), platinum (Pt), palladium (Pd), silicon (Si), silver (Ag), aluminum (Al), bismuth (Bi), tin (Sn), or zinc (Zn). In an embodiment, the metalloid may be a semiconductor. An amount of the second particle may be in a range of about 8 wt % to about 60 wt %, about 10 wt % to about 50 wt %, about 15 wt % to about 40 wt %, or about 20 wt % to about 30 wt %, based on the total weight of the mixture. When the amount of the second particle is within these ranges, cycle characteristics of the all-solid secondary battery 1 may improve.

The first anode active material layer 22 may include a binder. Examples of the binder may include at least one of styrene-butadiene rubber (SBR), polytetrafluoroethylene, polyvinylidene fluoride, polyethylene, a vinylidene fluoride/hexafluoropropylene copolymer, polyacrylonitrile, or polymethylmethacrylate, but embodiments are not limited thereto, and any suitable binder may be used. The binder may be formed of one of these binders alone or a plurality of different binders.

When the first anode active material layer 22 includes the binder, the first anode active material layer 22 is stabilized on the anode current collector 21. Also, cracks of the first anode active material layer 22 may be suppressed despite of volume change and/or relative location change of the first anode active material layer 22 during charge/discharge. For example, when the first anode active material layer 22 does not include a binder, the first anode active material layer 22 may be easily separated from the anode current collector 21. When the first anode active material layer 22 is detached from the anode current collector 21, the possibility of a short-circuit may increase as the anode current collector 21 contacts the solid electrolyte layer 30 at the exposed part of the anode current collector 21. The first anode active material layer 22 may be prepared by, for example, coating and drying a slurry, in which materials forming the first anode active material layer 22 are dispersed, on the anode current collector 21. When the binder is included in the first anode active material layer 22, the anode active material may be stably dispersed in the slurry. For example, when the slurry is coated on the anode current collector 21 by using a screen printing method, clogging of screen (e.g., screen clogging by an aggregate of the anode active material) may be suppressed.

The anode current collector 21 may be formed of, for example, a material that does not react with lithium, i.e., a material not capable of forming an alloy or a compound with lithium. Examples of the material forming the anode current collector 21 may include at least one of copper (Cu), stainless steel, titanium (Ti), iron (Fe), cobalt (Co), or nickel (Ni), but embodiments are not limited thereto, and any suitable electrode current collector may be used. The anode current collector 21 may be formed of one of these metals, an alloy thereof, or a coating material of at least two metals. The anode current collector 21 may be, for example, in the form of a plate or a foil.

The first anode active material layer 22 may further include additives, such as a filler, a dispersant, and an ion conducting agent that are suitable for use in an all-solid secondary battery 1.

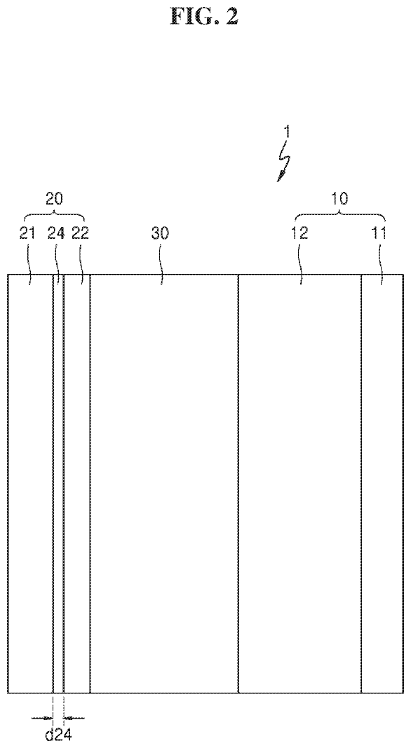

Referring to FIG. 2, the all-solid secondary battery 1 may further include, for example, a thin film 24 on the anode current collector 21, the thin film 24 including an element alloyable with lithium. The thin film 24 is disposed between the anode current collector 21 and the first anode active material layer 22. The thin film 24 may include, for example, an element alloyable with lithium. Examples of the element alloyable with lithium may include at least one of gold, silver, zinc, tin, indium, silicon, aluminum, or bismuth, but embodiments are not limited thereto, and any suitable element that is alloyable with lithium may be used. The thin film 24 is formed of any of these metals or an alloy of various metals. When the thin film 24 is disposed on the anode current collector 21, for example, the form of precipitation of a second anode active material layer (not shown) between the thin film 24 and the first anode active material layer 22 may be further flattened, and thus cycle characteristics of the all-solid secondary battery 1 may improve.

A thickness (d24) of the thin film 24 may be, for example, in a range of about 1 nm to about 800 nm, about 10 nm to about 700 nm, about 50 nm to about 600 nm, or about 100 nm to about 500 nm. When the thickness (d24) of the thin film 24 is less than 1 nm, the thin film 24 may not provide improved cycle characteristics. When the thickness (d24) of the thin film 24 is too thick, the thin film 24 itself absorbs lithium, and a precipitation amount of lithium in an anode may decrease, which results in deterioration of an energy density of the all-solid secondary battery 1, and thus cycle characteristics of the all-solid secondary battery 1 may deteriorate. The thin film 24 may be disposed on the anode current collector 21 by using, for example, vacuum vapor deposition, sputtering, or plating, but embodiments are not limited thereto, and any suitable method capable of forming a thin film may be used.

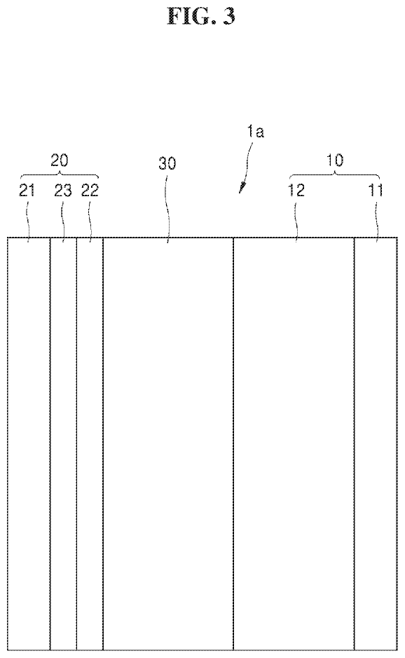

Referring to FIG. 3, the all-solid secondary battery 1a may further include, for example, a second anode active material layer 23 between the anode current collector 21 and the first anode active material layer 22 by charging the battery 1a. Although not shown in the drawings, for example, the all-solid secondary battery 1a may further include a second anode active material layer 23 disposed between the solid electrolyte layer 30 and the first anode active material layer 22 by charging the battery 1a or may further include a second anode active material layer 23 in the first anode active material layer 22 by charging the battery 1a. The second anode active material layer 23 is a metal layer including lithium or a lithium alloy. The metal layer includes lithium or a lithium alloy. When the second anode active material layer 23 is a metal layer including lithium, the second anode active material layer 23 may function as, for example, a lithium reservoir. Examples of the lithium alloy may include at least one of a Li—Al alloy, a Li—Sn alloy, a Li—In alloy, a Li—Ag alloy, a Li—Au alloy, a Li—Zn alloy, a Li—Ge alloy, or a Li—Si alloy, but embodiments are not limited thereto, and any suitable lithium alloy may be used. The second anode active material layer 23 may be formed of one of these alloys of lithium or may be formed of various alloys.

A thickness of the second anode active material layer 23 may be, for example, in a range of about 1 μm to about 1000 μm, about 1 μm to about 500 μm, about 1 μm to about 200 μm, about 1 μm to about 150 μm, about 1 μm to about 100 μm, or about 1 μm to about 50 μm, but embodiments are not limited thereto. When the thickness of the second anode active material layer 23 is too thin, the second anode active material layer 23 may not serve as a lithium reservoir. When the thickness of the second anode active material layer 23 is too thick, a weight and a volume of the all-solid secondary battery 1a increase, and cycle characteristics of the all-solid secondary battery 1a may deteriorate. The second anode active material layer 23 may be, for example, a metal foil having a thickness within these ranges.

In the all-solid secondary battery 1a, the second anode active material layer 23 may be disposed between the anode current collector 21 and the first anode active material layer 22 before assembling the all-solid secondary battery 1a or may be precipitated between the anode current collector 21 and the first anode active material layer 22 by charging after assembly of the all-solid secondary battery 1a.

When the second anode active material layer 23 is disposed between the anode current collector 21 and the first anode active material layer 22 before assembling the all-solid secondary battery 1a, the second anode active material layer 23 is a metal layer including lithium and thus may function as a lithium reservoir. Cycle characteristics of the all-solid secondary battery 1a including the second anode active material layer 23 may improve. For example, a lithium foil is disposed between the anode current collector 21 and the first anode active material layer 22 before assembling the all-solid secondary battery 1a.

When the second anode active material layer 23 is precipitated by charging after assembly of the all-solid secondary battery 1a, the all-solid secondary battery 1a does not include the second anode active material layer 23 during the assembly of the all-solid secondary battery 1a, and thus an energy density of the all-solid secondary battery 1a increases. For example, the all-solid secondary battery 1a may be charged over a charge capacity of the first anode active material layer 22. That is, the first anode active material layer 22 may be overcharged. In an initial stage of the charging, lithium is absorbed in the first anode active material layer 22. That is, an anode active material in the first anode active material layer 22 may form an alloy or a compound with lithium ions that migrated from the cathode layer 10. When the first anode active material layer 22 is charged over its capacity, for example, lithium is precipitated on a back surface of the first anode active material layer 22, which is between the anode current collector 21 and the first anode active material layer 22, and a metal layer corresponding to the second anode active material layer 23 may be formed by the precipitated lithium. The second anode active material layer 23 is a metal layer mainly formed of lithium (i.e., lithium metal). This is because, for example, the anode active material in the first anode active material layer 22 is formed of a material capable of forming an alloy or a compound with lithium. During discharge, lithium of the first anode active material layer 22 and the second anode active material layer 23, i.e., a metal layer, is ionized and migrated in a direction to the cathode layer 10. Thus, lithium may be used as an anode active material in the all-solid secondary battery 1a. Also, when the first anode active material layer 22 covers the second anode active material layer 23, the first anode active material layer 22 serves as a protection layer of the second anode active material layer 23, i.e., a metal layer, and suppresses precipitation growth of lithium dendrites at the same time. Accordingly, the possibility of a short-circuit and capacity deterioration of the all-solid secondary battery 1a may be suppressed, and, as a result, cycle characteristics of the all-solid secondary battery 1a may improve. Also, when the second anode active material layer 23 is formed by charging after the assembly of the all-solid secondary battery 1, the anode current collector 21, the first anode active material layer 22, and a region therebetween are, for example, Li-free regions that do not include lithium in the initial state or an after-discharge state of the all-solid secondary battery 1a.

An energy density of the all-solid secondary battery 1a may be, for example, about 800 Watt hours per liter (Wh/L) or more, about 850 Wh/L or more, about 900 Wh/L or more, or about 950 Wh/L or more. An energy density of the all-solid secondary battery 1a may be, for example, between about 800 Wh/L to about 3000 Wh/L, between about 800 Wh/L to about 2000 Wh/L, or between about 800 Wh/L to about 1000 Wh/L. When the all-solid secondary battery 1a has an energy density within these ranges, the all-solid secondary battery 1a may be appropriate to be used in the fields such as electric vehicles that require a battery having a high energy density.

According to an embodiment, a method of preparing the all-solid secondary battery includes providing an anode layer; providing a cathode layer including a cathode active material layer; providing a solid electrolyte layer between the anode layer and the cathode layer to prepare a stack; and pressing the stack, wherein the cathode active material layer is free of a conductive additive or includes a fibrous conductive additive, and when the cathode active material layer includes the fibrous conductive additive, an amount of the fibrous conductive additive is in a range of greater than 0 wt % to about 0.4 wt % based on the total weight of the cathode active material layer. When the cathode is free of a conductive additive or includes a fibrous conductive additive in a range of greater than 0 wt % to about 0.4 wt %, a cathode may have a small amount of a conductive additive and have an improved conductivity at the same time. Therefore, an energy density of an all-solid secondary battery including the cathode may increase, and cycle characteristics of the all-solid secondary battery may improve.

For example, the all-solid secondary battery 1 may be manufactured by preparing the cathode layer 10, the anode layer 20, and the solid electrolyte layer 30, each separately, and then stacking these layers.

Preparation of Cathode Layer

Materials forming the cathode active material layer 12, which are a cathode active material, a sulfide-based solid electrolyte, a fibrous conductive additive, and a binder, are added to a non-polar solvent to prepare a slurry. In an embodiment, the slurry does not include a conductive additive. The slurry thus prepared is coated and dried on the cathode current collector 11 to form a stack. The stack is pressed to prepare the cathode layer 10. Examples of the pressing may include at least one of roll pressing, flat pressing, or isostatic pressing, but embodiments are not limited thereto, and any suitable pressing method may be used. The pressing may be omitted. The mixture of the materials forming the cathode active material layer 12 is densification-molded in the form of a pellet or extension-molded in the form of sheet to prepare the cathode layer 10. When the cathode layer 10 is prepared in this manner, the cathode current collector 11 may be omitted. The cathode active material layer 12 may not include a conductive additive or may include a fibrous conductive additive. An amount of the fibrous conductive additive in the cathode active material layer 12 is in a range of greater than 0 wt % to about 0.4 wt %, based on the total weight of the cathode active material layer 12.

An average particle diameter of the sulfide-based solid electrolyte used in the preparation of the cathode active material layer 12 may be, for example, about 1 μm or less. An average particle diameter of the sulfide-based solid electrolyte used in the preparation of the cathode active material layer 12 may be, for example, in a range of about 0.1 μm to about 1 μm, about 0.2 μm to about 0.8 μm, or about 0.3 μm to about 0.7 μm. The average particle diameter of the sulfide-based solid electrolyte may be a volume-converted median diameter (D50) measured by using a laser-diffraction particle size distribution meter.

An average length of the fibrous conductive additive used in the preparation of the cathode active material layer 12 may be, for example, about 10 μm or more. An average length of the fibrous conductive additive used in the preparation of the cathode active material layer 12 may be, for example, in a range of about 10 μm to about 100 μm, about 15 μm to about 95 μm, about 20 μm to about 90 μm, about 25 μm to about 85 μm, or about 30 μm to about 80 μm.

Preparation of Anode Layer

Materials forming the first anode active material layer 22, which are an anode active material and a binder, are added to a polar solvent or a non-polar solvent to prepare a slurry. The slurry thus prepared is coated and dried on the anode current collector 21 to form a first stack. Subsequently, the dried first stack is pressed to prepare the anode layer 20. Examples of the pressing may include at least one of roll pressing or flat pressing, but embodiments are not limited thereto, and any suitable pressing method may be used. The pressing may be omitted.

Preparation of Solid Electrolyte Layer

The solid electrolyte layer 30 is prepared, for example, by using a solid electrolyte formed of sulfide-based solid electrolyte materials.

In the preparation of the sulfide-based solid electrolyte, starting materials may be treated by, for example, at least one of a melt-cooling method or a mechanical milling method, but embodiments are not limited thereto, and any suitable method of preparing a sulfide-based solid electrolyte may be used. For example, in the melt-cooling method, the starting materials such as Li₂S and P₂S₅ are mixed at a selected amount to form a pellet, which is then reacted in a vacuum at a selected reaction temperature and quenched to obtain a sulfide-based solid electrolyte material. The reaction temperature of the mixture of Li₂S and P₂S₅ is, for example, in a range of about 400° C. to about 1000° C., or about 800° C. to about 900° C. The reaction time may be, for example, in a range of about 0.1 hours to about 12 hours, or about 1 hour to about 12 hours. The cooling temperature of the reactants may be about 10° C. or less, or about 0° C. or less, and the cooling rate may be in a range of about 1° C./sec to about 10000° C./sec, or about 1° C./sec to about 1000° C./sec. For example, in the mechanical milling method, the starting materials such as Li₂S and P₂S₅ are reacted while stirring the materials using a ball mill to prepare a sulfide-based solid electrolyte material. Although the stirring rate and stirring time of the mechanical milling method are not limited, a production rate of the sulfide-based solid electrolyte material increases as the stirring rate increases, and a conversion rate to the sulfide-based solid electrolyte material increased as the stirring time increased. Next, after heat-treating the mixed materials obtained by the melt-cooling method or mechanical milling method at a selected temperature, the resultant is pulverized to prepare a solid electrolyte in the form of a particle. When the solid electrolyte has glass transition characteristics, the structure of the solid electrolyte may change from amorphous to crystalline by the heat-treatment.

The solid electrolyte thus obtained may be deposited by using, for example, a suitable layer-forming method such as an aerosol deposition method, a cold spray method, or a sputtering method to prepare the solid electrolyte layer 30. In an embodiment, the solid electrolyte layer 30 may be prepared by applying a pressure to a plurality of solid electrolyte particles. In an embodiment, a sulfide-based solid electrolyte, a solvent, and a binder are mixed to prepare a mixture, and the mixture is coated and dried on a substrate and then pressed to prepare the solid electrolyte layer 30.

An average particle diameter of the sulfide-based solid electrolyte used in the preparation of the solid electrolyte layer 30 may be, for example, greater than about 1 μm. An average particle diameter of the sulfide-based solid electrolyte used in the preparation of the solid electrolyte layer 30 may be, for example, in a range of about 1.1 μm to about 5 μm, about 2 μm to about 4.5 μm, or about 2.5 μm to about 4 μm. The average particle diameter of the sulfide-based solid electrolyte may be a volume-converted median diameter (D50) measured by using a laser-diffraction particle size distribution meter.

Preparation of all-Solid Secondary Battery

The cathode layer 10, the anode layer 20, and the solid electrolyte layer 30 are stacked such that the solid electrolyte 30 is between the cathode layer 10 and the anode layer 20 to prepare a stack, and the stack is pressed, thereby completing manufacture of the all-solid secondary battery 1.

For example, the solid electrolyte layer 30 is disposed on the cathode layer 10 to prepare a second stack. Then, the anode layer 20 is disposed on the second stack so that the solid electrolyte layer 30 and the first anode active material layer contact each other to prepare a third stack, and the third stack is pressed, thereby completing preparation of the all-solid secondary battery 1. Examples of the pressing may include at least one of roll pressing, flat pressing, or warm isostatic pressing (WIP), but embodiments are not limited thereto, and any suitable pressing method may be used. A pressure applied during the pressing may be, for example, in a range of about 50 megapascals (MPa) to about 750 MPa, about 200 MPa to about 600 MPa, or about 400 MPa to about 500 MPa. A time of applying the pressure may be in a range of about 5 milliseconds (ms) to about 60 minutes (min), about 1 second (sec) to about 50 min, about 1 min to about 40 min, about 3 min to about 38 min, about 5 min to about 36 min, or about 10 min to about 35 min. The pressing may be performed, for example, at room temperature or a temperature of about 90° C. or less, or in a range of about 20° C. to about 90° C. In an embodiment, the pressing may be performed at a high temperature of about 100° C. or more. For example, the solid electrolyte powder is sintered by the pressing and thus forms one solid electrolyte layer.

A composition and a preparation method of the all-solid secondary battery 1 are examples of embodiments, where elements of the composition and processes of the preparation method may be appropriately modified.

One or more embodiments will now be described in more detail with reference to the following examples. However, these examples are not intended to limit the scope of the one or more embodiments.

### EXAMPLES

### Example 1: CNF Conductive Additive 0 wt %

Preparation of Cathode Layer

LiNi_{0.8}Co_{0.15}Mn_{0.05}O₂ (NCM) was prepared as a cathode active material. Argyrodite type crystals, Li_{5.75}PS_{4.75}Cl_{1.25}, having an average particle diameter (D50) of 0.6 μm, were prepared as a solid electrolyte. A polytetrafluoroethylene (PTFE) binder (a Teflon binder available from DuPont) was prepared as a binder. A conductive additive was not used. These materials were mixed at a weight ratio of the cathode active material:solid electrolyte:conductive additive:binder equal to 90:10:0:1. Xylene was added to the mixture and stirred to prepare a slurry. The slurry was molded into the form of a sheet to prepare a cathode sheet. The cathode sheet was pressed on a surface of a cathode current collector formed of an aluminum foil coated with carbon at a thickness of 18 μm, thereby preparing a cathode layer.

Preparation of Solid Electrolyte Layer

1.5 parts by weight of an acryl-based binder (available from Zeon) with respect to 98.5 parts by weight of a solid electrolyte was added to the Li₅₇₅PS₄₇₅Cl_{1.25} solid electrolyte having an average particle diameter (D50) of 3.0 μm, and thus a mixture was prepared. Xylene was added to the mixture and stirred to prepare a slurry. Thus prepared slurry was coated on non-woven fabric by using a blade coater and dried in the air at a temperature of 25° C. to obtain a stack. The stacked structure was vacuum dried at a temperature of 60° C. for 2 hours. Therefore, a solid electrolyte layer was prepared according to these processes.

Preparation of Anode Layer

A SUS thin film having a thickness of 10 μm was prepared as an anode current collector. Also, carbon black (CB35) having a primary particle diameter of about 38 nm and silver (Ag) particles having an average particle diameter of about 60 nm were prepared as an anode active material.

The carbon black (CB35) and silver (Ag) particles were mixed at a weight ratio of 3:1 to prepare a powder mixture, and the powder mixture was used to prepare an anode. 4 g of the powder mixture was added to a container, 6 g of a NMP solution including 5 wt % of a PVDF binder (#9300 of Kureha) was added thereto to prepare a solution mixture. Subsequently, NMP was slowly added to the solution mixture and stirred to prepare a slurry. NMP was added to the slurry until a viscosity of the slurry was appropriate for preparing a film by using a blade coater. Thus prepared slurry was coated on a Ni foil by using a blade coater and dried in the air at a temperature of 80° C. for 20 minutes to obtain a stack. The stacked structure thus obtained was vacuum dried at a temperature of 100° C. for 12 hours. An anode layer was prepared according to these processes.

Preparation of all-Solid Secondary Battery

The solid electrolyte layer was disposed on the cathode active material layer of the cathode layer, and the anode layer was disposed on the solid electrolyte layer such that the anode active material layer contacts the solid electrolyte layer to prepare a stacked structure, and the stack was coated with a pouch. The coated stack was pressed by warm isostatic press (WIP) treatment at a temperature of 85° C. and a pressure of 500 MPa for 30 minutes to prepare an all-solid secondary battery.

### Example 2: 0.1 wt % of CNF Conductive Additive

An all-solid lithium battery was prepared in the same manner as in Example 1, except that carbon nanofibers (CNFs) having an aspect ratio of 30 with a diameter of about 1 μm and a length of 30 μm were used as a fibrous conductive additive and a mixture of a cathode active material, a solid electrolyte, a conductive additive, and a binder at a weight ratio of 89.9:10:0.1:1 was used.

### Example 3: 0.2 wt % of CNF Conductive Additive

An all-solid lithium battery was prepared in the same manner as in Example 1, except that CNFs having an aspect ratio of 30 with a diameter of about 1 μm and a length of 30 μm were used as a fibrous conductive additive and a mixture of a cathode active material, a solid electrolyte, a conductive additive, and a binder at a weight ratio of 89.8:10:0.2:1 was used.

### Example 4: 0.4 wt % of CNF Conductive Additive

An all-solid lithium battery was prepared in the same manner as in Example 1, except that CNFs having an aspect ratio of 30 with a diameter of about 1 μm and a length of 30 μm were used as a fibrous conductive additive and a mixture of a cathode active material, a solid electrolyte, a conductive additive, and a binder at a weight ratio of 89.6:10:0.4:1 was used.

### Comparative Example 1: 0.55 wt % of CNF Conductive Additive

An all-solid lithium battery was prepared in the same manner as in Example 1, except that CNFs having an aspect ratio of 30 with a diameter of about 1 μm and a length of 30 μm were used as a fibrous conductive additive and a mixture of a cathode active material, a solid electrolyte, a conductive additive, and a binder at a weight ratio of 89.45:10:0.55:1 was used.

### Comparative Example 2: 0.75 wt % of CNF Conductive Additive

An all-solid lithium battery was prepared in the same manner as in Example 1, except that CNFs having an aspect ratio of 30 with a diameter of about 1 μm and a length of 30 μm were used as a fibrous conductive additive and a mixture of a cathode active material, a solid electrolyte, a conductive additive, and a binder at a weight ratio of 89.25:10:0.75:1 was used.

### Comparative Example 3: 1.2 wt % of CNF Conductive Additive

An all-solid lithium battery was prepared in the same manner as in Example 1, except that CNFs having an aspect ratio of 30 with a diameter of about 1 μm and a length of 30 μm were used as a fibrous conductive additive and a mixture of a cathode active material, a solid electrolyte, a conductive additive, and a binder at a weight ratio of 88.8:10:1.2:1 was used.

### Comparative Example 4: 0.4 wt % of CB (in Particle Phase) Conductive Additive

An all-solid lithium battery was prepared in the same manner as in Example 1, except that carbon black (CB) having an average particle diameter of about 50 nm was used as a particle-phase conductive additive and a mixture of a cathode active material, a solid electrolyte, a conductive additive, and a binder at a weight ratio of 89.6:10:0.4:1 was used.

### Evaluation Example 1: Resistivity Evaluation

A resistivity of each of the cathodes prepared in Examples 1 to 4 and Comparative Examples 1 to 4 were measured in a thickness direction of the cathode by using a resistivity meter (available from CIS).

In the cathode, a thickness of the cathode current collector was about 18 μm, and a thickness of the cathode active material layer was about 100 μm A circular cathode plate having an area of about 3.14 cm² and a radius of about 1 cm was used as the cathode when taking the measurement.

The results of the measurement are shown in Table 1.

TABLE 1

| | Resistivity |
|---|---|
| | [mΩ · cm] |
| Example 1 (0 wt % of CNFs) | 0.58 |
| Example 2 (0.1 wt % of CNFs) | 0.78 |
| Example 3 (0.2 wt % of CNFs) | 0.44 |
| Example 4 (0.4 wt % of CNFs) | 0.52 |
| Comparative Example 1 (0.55 wt % of CNFs) | 3.6 |
| Comparative Example 2 (0.75 wt % of CNFs) | 5.1 |
| Comparative Example 3(1.2 wt % of CNFs) | 12.1 |
| Comparative Example 4 (0.4 wt % of CB) | 6.4 |

As shown in Table 1, resistivities of the cathodes prepared in Examples 1 to 4 having 0.4 wt % or less of the fibrous conductive additive decreased compared to those of the cathodes prepared in Comparative Examples 1 to 3 having greater than 0.4 wt % of the fibrous conductive additive. That is, electric conductivities of the cathodes prepared in Examples 1 to 4 were increased.

Thus, the cathodes prepared in Examples 1 to 4 having 0.4 wt % or less of the fibrous conductive additive had improved conductivities.

The cathode of Comparative Example 4 including a particle-phase conductive additive had a decreased conductivity.

### Evaluation Example 2: Capacity Retention Evaluation

Charge/discharge characteristics of the all-solid secondary batteries prepared in Examples 1 to 4 and Comparative Examples 1 to 4 were evaluated by the following charge/discharge test. The charge/discharge test was performed by placing each of the all-solid secondary batteries in a constant temperature chamber of 45° C.

In the first cycle, the batteries were charged with a constant current of 0.1 C until the battery voltage was 4.25 V and then discharged with a constant current of 0.1 C until the battery voltage was 2.5 V.

In the second cycle, the batteries were charged with a constant current of 0.1 C until the battery voltage was 4.25 V and then discharged with a constant current of 0.33 C until the battery voltage was 2.5 V.

In the third cycle, the batteries were charged with a constant current of 0.1 C until the battery voltage was 4.25 V and then discharged with a constant current of 1.0 C until the battery voltage was 2.5 V.

The discharge capacity and capacity retention in each cycle are shown in Table 2. The high rate characteristic is defined as shown in Equation 2.

High rate characteristic [%]=[Discharge capacity at 3^{rd} cycle (1 C rate)/discharge capacity at 1st cycle (0.1 C rate)]×100% Equation 2

TABLE 2

| | 0.1 C | 0.33 C | 1.0 C | |
|---|---|---|---|---|
| | Discharge | Discharge | Discharge | High rate |
| | capacity | capacity | capacity | characteristic |
| | [mAh/g] | [mAh/g] | [mAh/g] | [%] |
| Example 1 | 202 | 190 | 153 | 76 |
| (0 wt % of CNFs) | | | | |
| Example 2 | 197 | 190 | 167 | 85 |
| (0.1 wt % of CNFs) | | | | |
| Example 3 | 200 | 188 | 175 | 88 |
| (0.2 wt % of CNFs) | | | | |
| Example 4 | 201 | 189 | 171 | 85 |
| (0.4 wt % of CNFs) | | | | |
| Comparative Example 1 | 199 | 188 | 148 | 74 |
| (0.55 wt % of CNFs) | | | | |
| Comparative Example 2 | 203 | 189 | 136 | 67 |
| (0.75 wt % of CNFs) | | | | |
| Comparative Example 3 | 199 | 181 | 78 | 39 |
| (1.2 wt % of CNFs) | | | | |
| Comparative Example 4 | 202 | 189 | 127 | 63 |
| (0.4 wt % of CB) | | | | |

As shown in Table 2, high-rate characteristics of the all-solid secondary batteries prepared in Examples 1 to 4 having 0.4 wt % or less of the fibrous conductive additive improved compared to those of the all-solid secondary batteries prepared in Comparative Examples 1 to 3 having greater than 0.4 wt % of the fibrous conductive additive.

Also, the all-solid secondary batteries prepared in Examples 1 to 4 had smaller amounts of the conductive additives compared to those of the all-solid secondary batteries prepared in Comparative Examples 1 to 3 and thus may provide an increased energy density.

Therefore, the all-solid secondary batteries of Examples 1 to 4 provide an increased energy density and improved high rate characteristic than the all-solid secondary batteries of Comparative Examples 1 to 3.

For example, an energy density of the all-solid secondary battery of Example 1 was 950 Wh/L, and an energy density of the all-solid secondary battery of Comparative Example 3 was 870 Wh/L.

Also, the all-solid secondary battery of Comparative Example 4 including the particle-phase conductive additive had poor high rate characteristic compared to those of the all-solid secondary battery of Example 4 including the same amount of the fibrous conductive additive.

### Evaluation Example 3: Life Characteristic Evaluation

The all-solid secondary batteries prepared in Examples 1 to 4 and Comparative Examples 1 to 4 were evaluated by the following charge/discharge test. The charge/discharge test was performed by placing each of the all-solid secondary batteries in a constant temperature chamber of 45° C.

In the first cycle, the batteries were charged with a constant current of 0.33 C until the battery voltage was 4.25 V and then discharged with a constant current of 0.33 C until the battery voltage was 2.5 V.

From the second to 100th cycles, the batteries were charged and discharged in the same manner as in the first cycle.

Some of the measurement results are shown in Table 3. The capacity retention rate characteristics are defined as shown in Equation 3.

Capacity retention [%]=[Discharge capacity at 100th cycle/discharge capacity at 1^{st} cycle]×100% Equation 3

TABLE 3

| | Capacity retention |
|---|---|
| | [%] |
| Example 2 (CNF 0.1 wt %) | 97 |
| Example 3 (CNF 0.2 wt %) | 99 |
| Example 4 (CNF 0.4 wt %) | 95 |

As shown in Table 3, the all-solid secondary batteries of Examples 2 to 4 having 0.4 wt % or less of the fibrous conductive additive had excellent life characteristics.

### Evaluation Example 4: Contact Area Evaluation

Contact areas of the cathode active material and the solid electrolyte of the all-solid secondary batteries prepared in Examples 1 to 4 and Comparative Examples 1 to 4 were measured by using a galvanostatic intermittent titration technique (GITT).

In the first cycle, the batteries were charged with a constant current of 0.1 C until the battery voltage was 4.25 V, and then discharged with a constant current of 0.1 C or 0.33 C until a state of charged (SOC) reached 50%.

Subsequently, a constant current pulse of 0.1 C or 0.33 C was applied for 60 seconds, and relaxed for 2 hours to reach a steady state.

A voltage change (ΔEₜ) and an IR steady-state voltage change (ΔEₛ) in the duration for applying constant-current pulses excluding an IR-drop were measured, and the contact area of the cathode active material and the solid electrolyte was calculated as defined in Equation 1.

A percent of each of the contact areas calculated with respect to a theoretical contact area of the cathode active material is shown in Table 1. The theoretical contact area of the cathode active material is total surface area of the cathode active material particles contained in the cathode active material layer with an assumption that each cathode active material particle (i.e., NCM particle) is perfect sphere having a defined diameter.

D^{GITT}=(4/πτ)×(m_{B}V_{M}/M_{b}S)²×(ΔEₛ/ΔEₜ)² Equation 1

wherein, in Equation 1,

D^{GITT} is a diffusion coefficient of lithium ions;

T is a duration (sec) for applying constant-current pulses;

m_{B} is a mass (g) of the cathode active material;

V_{M} is a molar volume (cm³/mol) of the cathode active material;

M_{b} is a molar weight (g/mol) of the cathode active material;

S is a contact area (cm²) of the cathode active material and the electrolyte;

ΔEₛ is a steady-state voltage change (volt); and

ΔEₜ is a voltage change (volt) in the duration for applying constant-current pulses excluding an iR drop.

TABLE 4

| | Contact area [%] |
|---|---|
| Example 1 (0 wt % of CNFs) | 73 |
| Example 2 (0.1 wt % of CNFs) | 77 |
| Example 3 (0.2 wt % of CNFs) | 78 |
| Example 4 (0.4 wt % of CNFs) | 75 |
| Comparative Example 1 (0.55 wt % of CNFs) | 66 |
| Comparative Example 2 (0.75 wt % of CNFs) | 63 |
| Comparative Example 3 (1.2 wt % of CNFs) | 60 |
| Comparative Example 4 (0.4 wt % of CB) | 65 |

As shown in Table 4, the all-solid secondary batteries of Examples 1 to 4 having 0.4 wt % or less of the fibrous conductive additive had increased contact areas of the cathode active material and the solid electrolyte compared to the all-solid secondary batteries of Comparative Examples 1 to 3 having greater than 0.4 wt % of the fibrous conductive additive.

Also, the all-solid secondary battery of Comparative Example 4 including the particle-phase conductive additive had a decreased contact area compared to that of the all-solid secondary battery of Example 4 including the same amount of the fibrous conductive additive.

Therefore, the all-solid secondary batteries of Examples 1 to 4 may provide improved high rate characteristic and lifespan characteristics by having the increased contact areas.

As described above, according to one or more embodiments, the all-solid secondary battery may be used in various mobile devices or vehicles.

According to an aspect, provided is a cathode having an improved conductivity while having a small amount of a conductive additive.

According to an aspect, provided is an all-solid secondary battery having a high energy density and improved cycle characteristics by including the cathode.

It should be understood that embodiments described herein should be considered in a descriptive sense only and not for purposes of limitation. Descriptions of features, aspects, or advantages within each embodiment should be considered as available for other similar features, aspects, or advantages in other embodiments. While one or more embodiments have been described with reference to the figures, it will be understood by those of ordinary skill in the art that various changes in form and details may be made therein without departing from the spirit and scope as defined by the following claims.

What is claimed is:

1. A cathode comprising:
a cathode active material layer,
wherein the cathode active material layer comprises a cathode active material and a sulfide solid electrolyte, and
wherein the cathode active material layer is free of a conductive additive or comprises a fibrous conductive additive in a range of greater than 0 weight percent to about 0.4 weight percent, based on the total weight of the cathode active material layer.

2. The cathode of claim 1, wherein an aspect ratio of the fibrous conductive additive is about 10 to about 100.

3. The cathode of claim 1, wherein the fibrous conductive additive has a diameter of about 0.1 micrometer to about 1 micrometer and a length of about 10 micrometers to about 100 micrometers.

4. The cathode of claim 1, wherein the fibrous conductive additive is a carbonaceous material.

5. The cathode of claim 1, wherein the fibrous conductive additive is a 1-dimensional carbon nanostructure and is at least one of a carbon nanofiber, a carbon nanotube, a carbon nanobelt, or a carbon nanorod.

6. The cathode of claim 1, wherein an amount of the cathode active material is about 85 weight percent to 100 weight percent, based on the total weight of the cathode active material layer.

7. The cathode of claim 1, wherein the sulfide solid electrolyte comprises at least one of Li₂S—P₂S₅, Li₂S—P₂S₅—LiX, wherein X is a halogen atom, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn, wherein m and n are each a positive integer, and Z is at least one of Ge, Zn, or Ga, Li₂S—GeS₂, Li₂S—SiS₂—Li₃PO₄, or Li₂S—SiS₂-LiₚMO_{q}, wherein p and q are each a positive integer, and M is at least one of P, Si, Ge, B, Al, Ga, or In.

8. The cathode of claim 1, wherein the sulfide solid electrolyte comprises at least one of Li₇P₃S₁₁, Li₇PS₆, Li₄P₂S₆, Li₃PS₆, Li₃PS₄, or Li₂P₂S₆.

9. The cathode of claim 1, wherein the sulfide solid electrolyte comprises an argyrodite-type solid electrolyte represented by Formula 1:
Li₁₂₋ₙ₋ₓAX₆₋ₓY′ₓ Formula 1
wherein, in Formula 1,
A is at least one of P, As, Ge, Ga, Sb, Si, Sn, Al, In, Ti, V, Nb, or Ta,
X is at least one of S, Se, or Te,
Y′ is at least one of Cl, Br, I, F, CN, OCN, SCN, or N₃, and
n is an oxidation number of A, and 0≤x≤2.

10. The cathode of claim 9, wherein the argyrodite-type solid electrolyte comprises at least one of Li₇₋ₓPS₆₋ₓClₓ, wherein 0≤x≤2, Li₇₋ₓPS₆₋ₓBrₓ, wherein 0≤x≤2, or Li₇₋ₓPS₆₋ₓIₓ, wherein 0≤x≤2.

11. The cathode of claim 1, wherein a weight ratio of the sulfide solid electrolyte and the cathode active material in the cathode active material layer is in a range of about 1:8 to about 1:30.

12. The cathode of claim 1, wherein the cathode active material layer further comprises a binder.

13. The cathode of claim 1, wherein a contact area of the cathode active material and the sulfide solid electrolyte is about 67% to 100% more than a theoretical contact area of the cathode active material, calculated using a galvanostatic intermittent titration.

14. An all-solid secondary battery comprising:
the cathode of claim 1;
an anode comprising an anode current collector and a first anode active material layer; and
a solid electrolyte layer disposed between the cathode and the anode, wherein the solid electrolyte layer comprises a solid electrolyte.

15. The all-solid secondary battery of claim 14, wherein the solid electrolyte layer comprises the same sulfide solid electrolyte as in the cathode.

16. The all-solid secondary battery of claim 14, wherein an elastic modulus of the solid electrolyte in the solid electrolyte layer is in a range of about 15 gigapascals to about 35 gigapascals.

17. The all-solid secondary battery of claim 14, wherein the first anode active material layer comprises an anode active material that is capable of forming an alloy with lithium or a lithium-containing compound,
wherein the anode active material is in the form of a particle, and an average particle diameter of the anode active material is about 10 nanometers to about 4 micrometers.

18. The all-solid secondary battery of claim 17, wherein the anode active material comprises at least one of a carbonaceous anode active material, a metal anode active material, or metalloid anode active material, wherein the carbonaceous anode active material comprises amorphous carbon.

19. The all-solid secondary battery of claim 18, wherein the metal anode active material or metalloid anode active material comprises at least one of gold, platinum, palladium, silicon, silver, aluminum, bismuth, tin, or zinc.

20. The all-solid secondary battery of claim 17, wherein the anode active material comprises a mixture comprising a first particle comprising amorphous carbon and a second particle comprising a metal or a metalloid, wherein an amount of the second particle is in a range of about 8 weight percent to about 60 weight percent, based on the total weight of the mixture.

21. The all-solid secondary battery of claim 17, further comprising a film comprising an element alloyable with lithium on the anode current collector, wherein the thin film is disposed between the anode current collector and the first anode active material layer.

22. The all-solid secondary battery of claim 21, wherein a thickness of the film is in a range of about 1 nanometer to about 800 nanometers.

23. The all-solid secondary battery of claim 14, further comprising a second anode active material layer disposed in at least one of between the anode current collector and the first anode active material layer, between the solid electrolyte layer and the first anode active material layer, or in the first anode active material layer,
wherein the second anode active material layer is a metal layer comprising lithium or a lithium alloy.

24. The all-solid secondary battery of claim 14, wherein the anode current collector, the first anode active material layer, and a region therebetween are each independently a lithium-free region, wherein the lithium-free region does not comprise lithium in an initial state of the all-solid secondary battery or after charge of the all-solid secondary battery.

25. The all-solid secondary battery of claim 14, wherein an energy density of the all-solid secondary battery is about 800 Watt-hours per liter to about 3000 Watt-hours per liter.

26. A method of preparing an all-solid secondary battery, the method comprising:
providing an anode layer;
providing a cathode layer comprising a cathode active material layer;
providing a solid electrolyte layer between the anode layer and the cathode layer to prepare a stack; and
pressing the stack to prepare the all-solid secondary battery,
wherein, the cathode active material layer is free of a conducting additive or comprises a fibrous conductive additive in a range of greater than 0 weight percent to about 0.4 weight percent, based on the total weight of the cathode active material layer.
